(19) United States
(12) Patent Application Publication
(10) Pub. No.: US 2025/0056462 A1
(43) Pub. Date: Feb. 13, 2025

(54) METHOD AND SYSTEM FOR REGISTRATION SUPPORT

(71) Applicant: Verizon Patent and Licensing Inc., Basking Ridge, NJ (US)

(72) Inventors: Sudhakar Reddy Patil, Flower Mound, TX (US); Raquel Morera Sempere, Weehawken, NJ (US); David Taft, Keller, TX (US); Samirkumar Patel, Middlesex, NJ (US); Ambreen Habib, Golden, CO (US)

(21) Appl. No.: 18/366,796

(22) Filed: Aug. 8, 2023

(51) Int. Cl. H04W 60/00

(52) U.S. Cl. CPC H04W 60/00

(57) ABSTRACT

A method, a network device, and a non-transitory computer-readable storage medium are described in relation to an registration support service. The registration support service may include providing an end device with registration support information that may facilitate a re-registration of the end device with an access and mobility management function, a mobility management entity, or the like. The registration support information may include a time period and/or a location with which the end device may initiate a registration procedure. The registration support information may be generated based on historical behavior of the end device.

### BACKGROUND

Development and design of networks present certain challenges from a network-side perspective and an end device perspective. For example, Next Generation (NG) wireless networks, such as Fifth Generation New Radio (5G NR) networks are being deployed and are under development. End devices may be configured with network slice configuration information that may enable the end devices to access and use network slices.

### BRIEF DESCRIPTION OF THE DRAWINGS

FIG. 1 is a diagram illustrating an exemplary environment in which an exemplary embodiment of an registration support service may be implemented;

FIG. 2 is a diagram illustrating another exemplary environment in which an exemplary embodiment of the registration support service may be implemented;

FIG. 3 is a diagram illustrating yet another exemplary environment in which an exemplary embodiment of the registration support service may be implemented;

FIG. 4 is a diagram illustrating still another exemplary environment in which an exemplary embodiment of the registration support service may be implemented;

FIG. 5 is a diagram illustrating yet another exemplary environment in which an exemplary embodiment of the registration support service may be implemented;

FIG. 6 is a diagram illustrating exemplary components of a device that may correspond to one or more of the devices illustrated and described herein;

FIG. 7 is a flow diagram illustrating an exemplary process of an exemplary embodiment of the registration support service;

FIG. 8 is a flow diagram illustrating another exemplary process of an exemplary embodiment of the registration support service;

FIG. 9 is a flow diagram illustrating yet another exemplary process of an exemplary embodiment of the registration support service; and

FIG. 10 is a flow diagram illustrating still another exemplary process of an exemplary embodiment of the registration support service.

### DETAILED DESCRIPTION

The following detailed description refers to the accompanying drawings. The same reference numbers in different drawings may identify the same or similar elements. Also, the following detailed description does not limit the invention. An access and mobility management function (AMF) may initiate a user equipment (UE) configuration update procedure to update access and mobility management-related parameters and/or values included in a UE configuration. For example, the AMF may change network slice configuration. In the case of a change to allowed network slice selection assistance information (NSSAI), the AMF may provide an indication to the UE to initiate a registration procedure. The UE will not be able to connect to a single-NSSAI (S-NSSAI) included in a new configuration NSSAI which is not included in a new allowed NSSAI until the UE performs a registration procedure and includes a requested NSSAI based on the new configured NSSAI.

Typically, the network will provide new UE Route Selection Policy (URSP) rules to the UE when a network slice subscription changes. However, the time when the UE evaluates the new URSP rules and performs the re-registration is UE implementation dependent. For example, the UE may wait days, weeks, or even a longer period of time (e.g., a month, etc.) to perform the re-registration procedure and enable the UE to use the new configured NSSAI. The uncertainty as to when the UE may perform the re-registration may hamper the UE's ability to access and use network slices and application services supported by the network slices. For example, a new configured S-NSSAI may be used only when the UE is in a specific region and/or during a certain period of time according to a route selection descriptor (RSD) of a URSP rule.

According to exemplary embodiments, a registration support service is described. According to an exemplary embodiment, the registration support service may determine an optimum time for an end device to perform a re-registration procedure, as described herein. According to an exemplary embodiment, the registration support service may generate registration support information based on analytics information, such as network data analytics function (NWDAF) event and analytics information. For example, the registration support information may include time, location, and/or other context information that may provide guidance to the end device for performing the re-registration. The registration support information may correlate to the new configured S-NSSAI. According to various exemplary embodiments, the registration support service may provide the registration support information to the end device in a non-access stratum (NAS) message or a new URSP rule.

According to various exemplary embodiments, the registration support service may be provisioned according to various deployments (e.g., 5G non-standalone (NSA), SA, or a future wireless network type of deployment and/or connectivity service). According to an exemplary embodiment, a policy control function (PCF) or the like may generate the registration support information, as described herein. According to another exemplary embodiment, the AMF, a mobility management entity (MME), or the like may generate the registration support information, as described herein.

According to an exemplary embodiment, the end device may perform the registration procedure based on the registration support information, as described herein. For example, according to an SA scenario, the end device may trigger a service request (e.g., in CM-connected state), request release of a (UE) request, stop data transmission, and perform (initial) registration. According to an NSA scenario, the end device may perform an initial or a mobility registration based on the registration support information, as described herein.

In view of the foregoing, the registration support service may improve how updates to UE configuration, such as NSSAI, may be updated. The registration support service may minimize delay in provisioning UE configuration updates and enable access and use to various services afforded via the updated NSSAI by the end device.

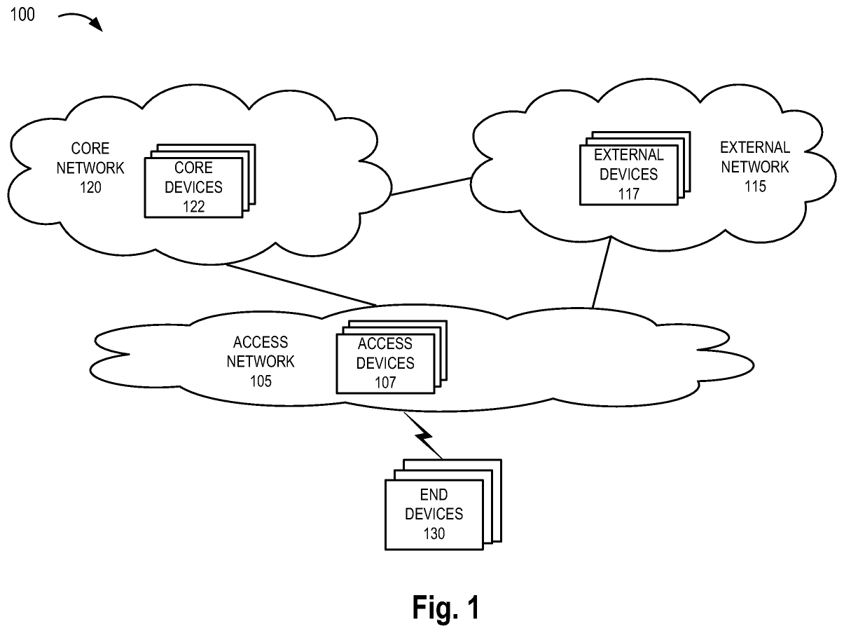

FIG. 1 is a diagram illustrating an exemplary environment 100 in which an exemplary embodiment of a registration support service may be implemented. As illustrated, environment 100 includes an access network 105, an external network 115, and a core network 120. Access network 105 includes access devices 107 (also referred to individually or generally as access device 107). External network 115 includes external devices 117 (also referred to individually or generally as external device 117). Core network 120 includes core devices 122 (also referred to individually or generally as core device 122). Environment 100 further includes end devices 130 (also referred to individually or generally as end device 130).

The number, type, and arrangement of networks illustrated in environment 100 are exemplary. For example, according to other exemplary embodiments, environment 100 may include fewer networks, additional networks, and/or different networks. For example, according to other exemplary embodiments, other networks not illustrated in FIG. 1 may be included, such as an X-haul network (e.g., backhaul, mid-haul, fronthaul, etc.), a transport network (e.g., Signaling System No. 7 (SS7), etc.), or another type of network that may support a wireless service and/or an application service, as described herein.

A network device, a network element, or a network function (referred to herein simply as a network device) may be implemented according to one or multiple network architectures, such as a client device, a server device, a peer device, a proxy device, a cloud device, and/or a virtualized network device. Additionally, a network device may be implemented according to various computing architectures, such as centralized, distributed, cloud (e.g., elastic, public, private, etc.), edge, fog, and/or another type of computing architecture, and may be incorporated into distinct types of network architectures (e.g., Software Defined Networking (SDN), client/server, peer-to-peer, etc.) and/or implemented with various networking approaches (e.g., logical, virtualization, network slicing, etc.). The number, the type, and the arrangement of network devices are exemplary.

Environment 100 includes communication links between the networks and between the network devices. Environment 100 may be implemented to include wired, optical, and/or wireless communication links. A communicative connection via a communication link may be direct or indirect. For example, an indirect communicative connection may involve an intermediary device and/or an intermediary network not illustrated in FIG. 1. A direct communicative connection may not involve an intermediary device and/or an intermediary network. The number, type, and arrangement of communication links illustrated in environment 100 are exemplary.

Environment 100 may include various planes of communication including, for example, a control plane, a user plane, a service plane, and/or a network management plane. Environment 100 may include other types of planes of communication. A message communicated in support of the registration support service may use at least one of these planes of communication. Additionally, an interface of a network device may be modified (e.g., relative to an interface defined by a standards body, such as Third Generation Partnership Project (3GPP), 3GPP2, International Telecommunication Union (ITU), European Telecommunications Standards Institute (ETSI), GSM Association (GSMA), etc.) or a new interface of the network device may be provided in order to support the communication (e.g., transmission and reception of messages, information elements (IE), attribute value pairs (AVPs), etc.) between network devices and the recommendation support service logic of the network device, as described herein. According to various exemplary implementations, the interface of the network device may be a service-based interface, a reference point-based interface, an Open Radio Access Network (O-RAN) interface, or some other type of interface.

Access network 105 may include one or multiple networks of one or multiple types and technologies. For example, access network 105 may be implemented to include a 5G RAN, a future generation RAN (e.g., a Sixth Generation (6G) RAN, a Seventh Generation (7G) RAN, or a subsequent generation RAN), a centralized-RAN (C-RAN), an O-RAN, and/or another type of access network. Access network 105 may include a legacy RAN (e.g., a Third Generation (3G) RAN, a 4G or 4.5 RAN, etc.). Access network 105 may communicate with and/or include other types of access networks, such as, for example, a Wi-Fi network, a Worldwide Interoperability for Microwave Access (WiMAX) network, a local area network (LAN), a Citizens Broadband Radio System (CBRS) network, a cloud RAN, a virtualized RAN (vRAN), a self-organizing network (SON), a wired network (e.g., optical, cable, etc.), or another type of network that provides access to or can be used as an on-ramp to access network 105.

Access network 105 may include different and multiple functional splitting, such as options 1, 2, 3, 4, 5, 6, 7, or 8 that relate to combinations of access network 105 and core network 120 including an Evolved Packet Core (EPC) network and/or an NG core (NGC) network, or the splitting of the various layers (e.g., physical layer, media access control (MAC) layer, radio link control (RLC) layer, and packet data convergence protocol (PDCP) layer, etc.), plane splitting (e.g., user plane, control plane, etc.), interface splitting (e.g., F1-U, F1-C, E1, Xn-C, Xn-U, X2-C, Common Public Radio Interface (CPRI), etc.) as well as other types of network services, such as dual connectivity (DC) or higher (e.g., a secondary cell group (SCG) split bearer service, a master cell group (MCG) split bearer, an SCG bearer service, non-standalone (NSA), standalone (SA), etc.), carrier aggregation (CA) (e.g., intra-band, inter-band, contiguous, non-contiguous, etc.), edge and core network slicing, coordinated multipoint (COMP), various duplex schemes (e.g., frequency division duplex (FDD), time division duplex (TDD), half-duplex FDD (H-FDD), etc.), and/or another type of connectivity service (e.g., NSA NR, SA NR, a future connectivity service/deployment, etc.).

According to some exemplary embodiments, access network 105 may be implemented to include various architectures of wireless service, such as, for example, macrocell, microcell, femtocell, picocell, metrocell, NR cell, Long Term Evolution (LTE) cell, non-cell, or another type of wireless architecture. Additionally, according to various exemplary embodiments, access network 105 may be implemented according to various wireless technologies (e.g., RATs, etc.), and various wireless standards, frequencies, bands, and segments of radio spectrum (e.g., centimeter (cm) wave, millimeter (mm) wave, below 6 gigahertz (GHz), above 6 GHz, higher than mm wave, C-band, licensed radio spectrum, unlicensed radio spectrum, above mm wave), and/or other attributes or technologies used for radio communication. Additionally, or alternatively, according to some exemplary embodiments, access network 105 may be implemented to include various wired and/or optical architectures for wired and/or optical access services.

Depending on the implementation, access network 105 may include one or multiple types of network devices, such as access devices 107. For example, access device 107 may include a next generation Node B (gNB), an enhanced LTE evolved Node B (eLTE eNB), an eNB, a radio network controller (RNC), a radio intelligent controller (RIC), a base station controller (BSC), a remote radio head (RRH), a baseband unit (BBU), a radio unit (RU), a remote radio unit (RRU), a centralized unit (CU), a CU-control plane (CP), a CU-user plane (UP), a distributed unit (DU), a small cell node (e.g., a picocell device, a femtocell device, a microcell device, a home eNB, a home gNB, etc.), an open network device (e.g., O-RAN Centralized Unit (O-CU), O-RAN Distributed Unit (O-DU), O-RAN next generation Node B (O-gNB), O-RAN evolved Node B (O-eNB)), a 5G ultra-wide band (UWB) node, a future generation wireless access device (e.g., a 6G wireless station, a 7G wireless station, or another generation of wireless station), or another type of wireless node (e.g., a WiFi device, a WiMax device, a hotspot device, a fixed wireless access customer premises equipment (FWA CPE), etc.) that provides a wireless access service. Additionally, access devices 107 may include a wired and/or an optical device (e.g., modem, wired access point, optical access point, Ethernet device, multiplexer, etc.) that provides network access and/or transport service.

According to some exemplary implementations, access device 107 may include a combined functionality of multiple radio access technologies (RATs) (e.g., 4G and 5G functionality, 5G and 5.5G functionality, etc.) via soft and hard bonding based on demands and needs. According to some exemplary implementations, access device 107 may include a split access device (e.g., a CU-control plane (CP), a CU-user plane (UP), etc.) or an integrated functionality, such as a CU-CP and a CU-UP, or other integrations of split RAN nodes. Access device 107 may be an indoor device or an outdoor device.

External network 115 may include one or multiple networks of one or multiple types and technologies that provide an application service. For example, external network 115 may be implemented using one or multiple technologies including, for example, network function virtualization (NFV), software defined networking (SDN), cloud computing, Infrastructure-as-a-Service (IaaS), Platform-as-a-Service (PaaS), Software-as-a-Service (SaaS), or another type of network technology. External network 115 may be implemented to include a cloud network, a private network, a public network, a MEC network, a fog network, the Internet, a packet data network (PDN), a service provider network, the World Wide Web (WWW), an Internet Protocol Multimedia Subsystem (IMS) network, a Rich Communication Service (RCS) network, a software-defined (SD) network, a virtual network, a packet-switched network, a data center, a data network, or other type of application service layer network that may provide access to and may host an end device application service.

Depending on the implementation, external network 115 may include various network devices such as external devices 117. For example, external devices 117 may include virtual network devices (e.g., virtualized network functions (VNFs), servers, host devices, application functions (AFs), application servers (ASs), server capability servers (SCSs), containers, hypervisors, virtual machines (VMs), pods, network function virtualization infrastructure (NFVI), and/or other types of virtualization elements, layers, hardware resources, operating systems, engines, etc.) that may be associated with application services for use by end devices 130. By way of further example, external devices 117 may include mass storage devices, data center devices, NFV devices, SDN devices, cloud computing devices, platforms, and other types of network devices pertaining to various network-related functions (e.g., security, management, charging, billing, authentication, authorization, policy enforcement, development, etc.). Although not illustrated, external network 115 may include one or multiple types of core devices 122, as described herein.

External devices 117 may host one or multiple types of application services. For example, the application services may pertain to broadband services in dense areas (e.g., pervasive video, smart office, operator cloud services, video/photo sharing, etc.), broadband access everywhere (e.g., 50/100 Mbps, ultra-low-cost network, etc.), enhanced mobile broadband (eMBB), higher user mobility (e.g., high speed train, remote computing, moving hot spots, etc.), Internet of Things (e.g., smart wearables, sensors, mobile video surveillance, smart cities, connected home, etc.), extreme real-time communications (e.g., tactile Internet, augmented reality (AR), virtual reality (VR), etc.), lifeline communications (e.g., natural disaster, emergency response, etc.), ultra-reliable communications (e.g., automated traffic control and driving, collaborative robots, health-related services (e.g., monitoring, remote surgery, etc.), drone delivery, public safety, etc.), broadcast-like services, communication services (e.g., email, text (e.g., Short Messaging Service (SMS), Multimedia Messaging Service (MMS), etc.), massive machine-type communications (mMTC), voice, video calling, video conferencing, instant messaging), video streaming, fitness services, navigation services, and/or other types of wireless and/or wired application services. External devices 117 may also include other types of network devices that support the operation of external network 115 and the provisioning of application services, such as an orchestrator, an edge manager, an operations support system (OSS), a local domain name system (DNS), registries, and/or external devices 117 that may pertain to various network-related functions (e.g., security, management, charging, billing, authentication, authorization, policy enforcement, development, etc.). External devices 117 may include non-virtual, logical, and/or physical network devices.

Core network 120 may include one or multiple networks of one or multiple network types and technologies. Core network 120 may include a complementary network of access network 105. For example, core network 120 may be implemented to include a 5G core network, an evolved packet core (EPC) of an LTE network, an LTE-Advanced (LTE-A) network, and/or an LTE-A Pro network, a future generation core network (e.g., a 5.5G, a 6G, a 7G, or another generation of core network), and/or another type of core network.

Depending on the implementation of core network 120, core network 120 may include diverse types of network devices that are illustrated in FIG. 1 as core devices 122. For example, core devices 122 may include a user plane function (UPF), a Non-3GPP Interworking Function (N3IWF), an AMF, a session management function (SMF), a unified data management (UDM) device, a unified data repository (UDR), an authentication server function (AUSF), a security anchor function (SEAF), a network slice selection function (NSSF), a network repository function (NRF), a PCF, an NWDAF, a network exposure function (NEF), a service capability exposure function (SCEF), a lifecycle management (LCM) device, an MME, a packet data network gateway (PGW), an enhanced packet data gateway (ePDG), a serving gateway (SGW), a home agent (HA), a General Packet Radio Service (GPRS) support node (GGSN), a home subscriber server (HSS), an authentication, authorization, and accounting (AAA) server, a policy and charging rules function (PCRF), a policy and charging enforcement function (PCEF), and/or a charging system (CS).

According to other exemplary implementations, core devices 122 may include additional, different, and/or fewer network devices than those described. For example, core devices 122 may include a non-standard or a proprietary network device, and/or another type of network device that may be well-known but not particularly mentioned herein. Core devices 122 may also include a network device that provides a multi-RAT functionality (e.g., 4G and 5G, 5G and 5.5G, 5G and 6G, etc.), such as an SMF with PGW control plane functionality (e.g., SMF+PGW-C), a UPF with PGW user plane functionality (e.g., UPF+PGW-U), and/or other combined nodes (e.g., an HSS with a UDM and/or UDR, an MME with an AMF, etc.). Also, core devices 122 may include a split core device 122. For example, core devices 122 may include a session management (SM)-PCF, an access management (AM)-PCF, a user equipment (UE)-PCF, and/or another type of split architecture associated with another core device 122, as described herein.

According to an exemplary embodiment, at least some of core devices 122 include logic of an exemplary embodiment of the registration support service, as described herein. For example, such core devices 122 may perform network slice subscription change procedures, generate and provide registration support information, and provide the registration support information to end device 130. The registration support information may provide guidance to end device 130 regarding registration or re-registration with core network 120, as described herein.

End device 130 may include a device that may have communication capabilities (e.g., wireless, wired, optical, etc.). End device 130 may or may not have computational capabilities. End device 130 may be implemented as a mobile device, a portable device, a stationary device (e.g., a non-mobile device and/or a non-portable device), a device operated by a user, or a device not operated by a user. For example, end device 130 may be implemented as a smartphone, a mobile phone, a personal digital assistant, a tablet, a netbook, a wearable device (e.g., a watch, glasses, headgear, a band, etc.), a computer, a gaming device, a television, a set top box, a music device, an IoT device, a drone, a smart device, a fixed wireless device, a router, a sensor, an automated guided vehicle (AGV), an industrial robot, or other type of wireless device (e.g., other type of user equipment (UE)). End device 130 may be configured to execute various types of software (e.g., applications, programs, etc.). The number and the types of software may vary among end devices 130. End device 130 may include “edge-aware” and/or “edge-unaware” application service clients. For purposes of description, end device 130 is not considered a network device. End device 130 may be implemented as a virtualized device in whole or in part.

End device 130 may include logic of an exemplary embodiment of the registration support service. For example, end device 130 may obtain registration support information pertaining to a change to allowed NSSAI, as described herein. End device 130 may use the registration support information to facilitate registration or re-registration with core network 120, as described herein.

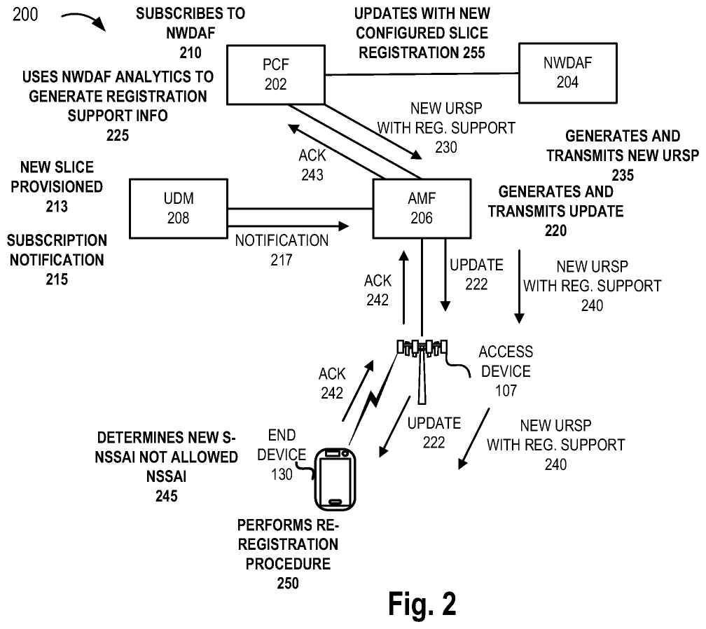

FIG. 2 is a diagram illustrating another exemplary environment in which an exemplary process 200 of an exemplary embodiment of the registration support service may be implemented. As illustrated, the exemplary environment may include a PCF 202, an NWDAF 204, an AMF 206, a UDM 208, access device 107, and end device 130. According to exemplary embodiment, the environment includes a 5G SA deployment. For example, access device 107 may be implemented as a cellular wireless station, such as a gNB.

PCF 202, NWDAF 204, AMF 206, and UDM 208 may each include logic that provides functions and/or services described or defined by a standards body, such as 3GPP, 3GPP2, ITU, ETSI, GSMA, and/or the like. For example, PCF 202 may provide policies/rules to control plane network devices, and make policy decisions based on subscription information, among other functions. NWDAF 204 may consume statistics, metrics, and events from 5G network functions, retrieve management statistics from an Operations, Administration, and Maintenance (OAM) device, provide network function discovery and identification, perform machine learning (ML) modeling, network optimization, cost efficiency, resource management, among other functions. AMF 206 may provide registration, connection, reachability, and mobility management, security context management, location service management, UE mobility event notification, among other functions. UDM 208 may manage data for access authorization, user registration, and data network policies, among other functions. According to an exemplary embodiment, PCF 202, NWDAF 204, AMF 206, and UDM 208 may each include logic that provides a function of an exemplary embodiment of the registration support service, as described herein.

Referring to FIG. 2, according to an exemplary scenario, assume that end device 130 is in a 5G SA coverage area. According to this example, end device 130 may receive registration support information after a new configured NSSAI is received by end device 130.

As illustrated, PCF 202 may subscribe to NWDAF 204 for NWDAF event and/or analytics information 210 (referred to as NWDAF information). For example, the subscription of PCF 202 may include NWDAF information pertaining to active network slices and UE behavior when end device 130 is in a CM-idle state and/or a CM-connected state. The information may include mobility information (e.g., time periods, locations, etc.) pertaining to end device 130. UDM 208 may be provisioned with new network slice information 213, and in response, UDM 208 may invoke a subscription notification procedure 215. For example, UDM 208 may generate and transmit a notification 217 to AMF 206. Notification 217 may include new configured NSSAI that pertains to end device 130. In response to receiving and analyzing notification 217, AMF 206 may generate and transmit an update to end device 130. For example, an update 222 may include a configuration update command message (with an acknowledge request) to end device 130. The configuration update command message may include the new configured NSSAI. AMF 206 may transmit the update when end device 130 is in a CM-CONNECTED state.

PCF 202 may be notified of the new configured NSSAI as a part of an NSSAI provisionment procedure (not illustrated). Based on the NWDAF information received from NWDAF 204, PCF 202 may use this information to generate registration support information 225. As previously described, NWDAF information may include historical information pertaining to active network slices and UE behavior when end device 130 is in a CM-idle state and/or a CM-connected state, mobility information (e.g., time periods, locations, etc.) pertaining to end device 130, and/or other NWDAF events. PCF 202 may calculate an optimum time during which and/or a location (e.g., a tracking area, a registration area that may include one or multiple tracking areas, or another geographic area (e.g., a sector, a sub-sector of access device 107, etc.)) at which end device 130 may perform a re-registration with AMF 206 in relation to the new configured NSSAI. The registration support information may also indicate the time during which end device 130 may access and use a new allowed NSSAI or S-SSNAI at the given location. As illustrated, PCF 202 may provide a new URSP rule, which includes the registration support information 230, to AMF 206.

In response to receiving the new URSP rule, AMF 206 may determine to provide the new URSP rule with registration support information 240, to end device 130. Based on the new URSP rule and registration support information, end device 130 may determine that a new S-NSSAI is not part of the current allowed NSSAI 245. End device 130 may evaluate the new URSP rule and identify the registration support information. End device 130 may transmit an acknowledgement 242 to AMF 206 regarding receipt of the new URSP rule and registration support information. In response, AMF 206 may transmit an acknowledgement 243 to PCF 202.

Based on the registration support information, end device 130 may perform a registration procedure 250 with AMF 206. For example, end device 130 may generate and transmit a service request when in a CM-connected state, request a release of the (UE) connection, stop data transmission, and perform a re-registration with AMF 206. Additionally, PCF 202 and NWDAF 204 may update with new configured slice registration 255.

The environment depicted in FIG. 2 is exemplary and according to other embodiments, the environment may include additional and/or fewer network devices. For example, although not illustrated, there may be other types of core devices 122 and/or access devices 107, as described herein. The messages described in relation to process 200 are exemplary. Additionally, process 200 may include additional, fewer, and/or different steps than those described in relation to FIG. 2 according to other exemplary scenarios.

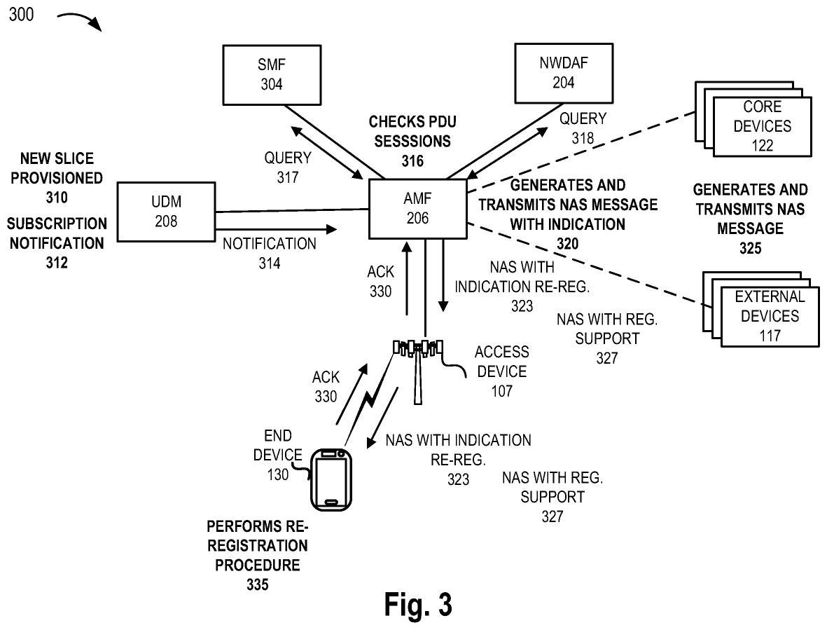

FIG. 3 is a diagram illustrating yet another exemplary environment in which an exemplary process 300 of an exemplary embodiment of the registration support service may be implemented. As illustrated, the exemplary environment may include NWDAF 204, AMF 206, UDM 208, an SMF 304, access device 107, and end device 130. The exemplary environment may further include other core devices 122 and/or external devices 117, as described herein. According to exemplary embodiment, environment includes a 5G SA deployment. For example, access device 107 may be implemented as a cellular wireless station, such as a gNB.

SMF 304 may provide session management, Internet Protocol (IP) address allocation and management, selection, and control of user plane (UP) function, configuration of traffic steering, control of policy enforcement and quality of service (QOS), among other functions. SMF 304 may include logic of an exemplary embodiment of the registration support service, as described herein.

Referring to FIG. 3, UDM 208 may be provisioned with new network slice information 310, and in response, UDM 208 may invoke a subscription notification procedure 312. For example, UDM 208 may generate and transmit a notification 314 to AMF 206. Notification 314 may include new configured NSSAI that pertains to end device 130. In response to receiving and analyzing notification 314, AMF 206 may determine whether new slice subscription re-registration can be done immediately with an indicator for re-registration sent as a part of a service request accept or a registration accept. For example, AMF 206 may check whether end device 130 has any active PDU sessions 316 with SMF 304 and/or NWDAF 204. As illustrated, AMF 206 may transmit a query 317 and/or a query 318 to SMF 304 and/or NWDAF 204. According to other embodiments, AMF 206 may query other core devices 122 and/or external devices 117, as depicted in FIG. 3. When AMF 206 determines there is an active PDU session, AMF 206 may generate and transmit a NAS message 320, which includes an indication to re-register with AMF 206, to end device 130. For example, the NAS message with the indication to re-register 323 (e.g., a service request accept message or a registration accept message) may be transmitted to end device 130.

When AMF 206 determines that there is not an active PDU session, AMF 206 may generate and transmit a NAS message 325. For example, the NAS message may include registration support information 327. For example, the NAS message may be implemented as an initial registration accept, a service configuration accept, or a configuration update command depending on the context. In response to receiving the NAS message (with registration support information), end device 130 may transmit an acknowledgement 330 to AMF 206.

Based on the registration support information, end device 130 may perform a registration procedure 335. For example, end device 130 may generate and transmit a service request when in a CM-connected state, request a release of the (UE) connection, stop data transmission, and perform re-registration with AMF 206. End device 130 may use the newly configured NSSAI as the requested NSSAI during the registration. As a consequence, if an S-NSSAI is requested by end device 130 and supported by subscription and a RAN of the area and/or time, end device 130 may have access and use of the network slice given that the newly configured NSSAI is part of the allowed NSSAI from AMF 206. End device 130 may ignore duplicate registration support information if received in subsequent NAS messages from AMF 206 for any reason.

The environment depicted in FIG. 3 is exemplary and according to other embodiments, the environment may include additional and/or fewer network devices. For example, although not illustrated, there may be other types of core devices 122 and/or access devices 107, as described herein. The messages described in relation to process 300 are exemplary. Additionally, process 300 may include additional, fewer, and/or different steps than those described in relation to FIG. 3 according to other exemplary scenarios.

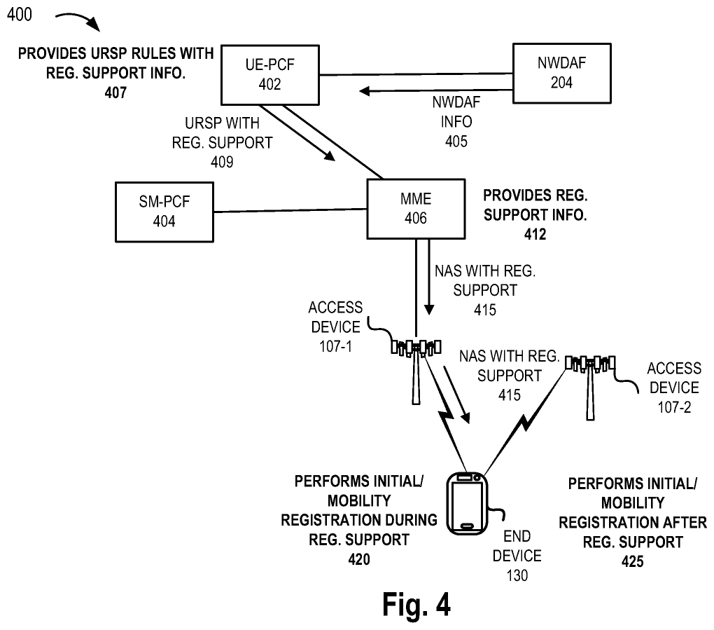

FIG. 4 is a diagram illustrating still another exemplary environment in which an exemplary process 400 of an exemplary embodiment of the registration support service may be implemented. As illustrated, exemplary environment 400 may include a UE-PCF 402, an NWDAF 204, an SM-PCF 404, an MME 406, access devices 107-1 and 107-2, and end device 130. According to exemplary embodiment, environment includes an NSA/LTE deployment. For example, access device 107-1 may be implemented as a cellular wireless station, such as an eNB, and access device 107-2 may be implemented as a gNB.

According to an exemplary embodiment of process 400, the registration support information may be provided to end device 130 during an Evolved Packet System (EPS) attach procedure or a Fifth Generation System (5GS) to an EPS handover.

UE-PCF 402 may manage UE policy information, which includes URSP rules, and provide UE policy control services, among other functions. UE-PCF 402 may include logic that provides an exemplary embodiment of the registration support service, as described herein. SM-PCF 404 may manage session management policies and provide session management control services (e.g., policy and charging control (PCC) rules), among other functions. MME 406 may manage network access, authenticate, and authorize users, select SGW and PGW, keep track of end devices 130 that are registered, among other functions. MME 406 may include logic that provides an exemplary embodiment of the registration support service, as described herein.

Referring to FIG. 4, assume that a new network slice is provisioned when end device 130 is performing an initial EPC attach or a handover from a 5GS to an LTE network. SM-PCF 404 may establish a UE policy association towards UE-PCF 402 upon the initial EPC attach or the handover. Thereafter, UE-PCF 402 may provide a new URSP rule that includes registration support information 407 to MME 406. For example, UE-PCF 402 may transmit a new URSP rule with registration support information 409 to MME 406.

UE-PCF 402 may generate the new URSP rules with the registration support information based on the NWDAF information 405. For example, similar to that previously described in relation to PCF 202, UE-PCF 402 may subscribe to NWDAF 204 for NWDAF information, and as illustrated, may receive NWDAF information 405 from NWDAF 204. UE-PCF 402 may calculate an optimum time during which and/or a location (e.g., a tracking area, a registration area that may include one or multiple tracking areas, or another geographic area (e.g., a sector, a sub-sector of access device 107, etc.) at which end device 130 may perform a re-registration. The registration support information may also indicate a time period during which end device 130 may access and use a new allowed NSSAI or S-SSNAI at a given location.

Based on receiving the new URSP rule that includes the registration support information, MME 406 may provide the registration support information 412 to end device 130 during the initial EPC attach procedure or the 5GS to EPS handover procedure. For example, MME 405 may transmit a NAS message that includes the registration support information 415.

Depending on various exemplary scenarios, if end device 130 performs an initial or mobility registration in an SA coverage area that aligns with the parameters of the registration support information (e.g., during registration support) 420, end device 130 may use the newly configured NSSAI as the requested NSSAI. As a consequence, if an S-NSSAI is requested by end device 130 and supported by subscription and a RAN of the area and/or time, end device 130 may have access and use of the network slice given that the newly configured NSSAI is part of the allowed NSSAI. End device 130 may ignore duplicate registration support information if received in NAS messages. On the other hand, if end device 130 performs an initial or mobility registration in an SA coverage area that does not align with the parameters of the registration support information (e.g., after registration support) 425, end device 130 may use the registration support information provided in a registration accept.

The environment depicted in FIG. 4 is exemplary and according to other embodiments, the environment may include additional and/or fewer network devices. For example, although not illustrated, there may be other types of core devices 122 and/or access devices 107, as described herein. The messages described in relation to process 400 are exemplary. Additionally, process 400 may include additional, fewer, and/or different steps than those described in relation to FIG. 4 according to other exemplary scenarios.

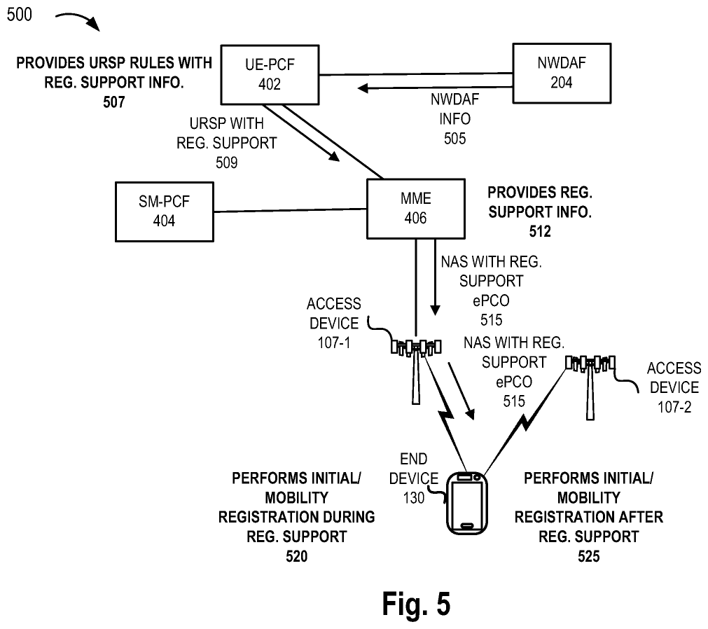

FIG. 5 is a diagram illustrating yet another exemplary environment in which an exemplary process 500 of an exemplary embodiment of the registration support service may be implemented. As illustrated, the exemplary environment may include UE-PCF 402, NWDAF 204, SM-PCF 404, MME 406, access devices 107, and end device 130, as previously described in relation to FIG. 4. In contrast to process 400 of FIG. 4, assume that the delivery of the registration support information occurs after end device 130 may already be registered in an NSA/LTE network.

Steps 505, 507, and 509 may be similar to those described in relation to steps 405, 407, and 409 of process 400 depicted in FIG. 4. Based on receiving the new URSP rule that includes the registration support information, MME 406 may provide the registration support information 512 to end device 130. For example, MME 405 may transmit a NAS message that includes the registration support information 515, which may be implemented as an extended Protocol Configuration Option (ePCO) or other suitable IE.

Depending on various exemplary scenarios, if end device 130 performs an initial or mobility registration in an SA coverage area that aligns with the parameters of the registration support information (e.g., during registration support) 520, end device 130 may use the newly configured NSSAI as the requested NSSAI. As a consequence, if an S-NSSAI is requested by end device 130 and supported by subscription and a RAN of the area and/or time, end device 130 may have access and use of the network slice given that the newly configured NSSAI is part of the allowed NSSAI. End device 130 may ignore duplicate registration support information if received in NAS messages. On the other hand, if end device 130 performs an initial or mobility registration in an SA coverage area that does not align with the parameters of the registration support information (e.g., after registration support) 525, end device 130 may use the registration support information provided in a registration accept.

The environment depicted in FIG. 5 is exemplary and according to other embodiments, the environment may include additional and/or fewer network devices. For example, although not illustrated, there may be other types of core devices 122 and/or access devices 107, as described herein. The messages described in relation to process 500 are exemplary. Additionally, process 500 may include additional, fewer, and/or different steps than those described in relation to FIG. 5 according to other exemplary scenarios.

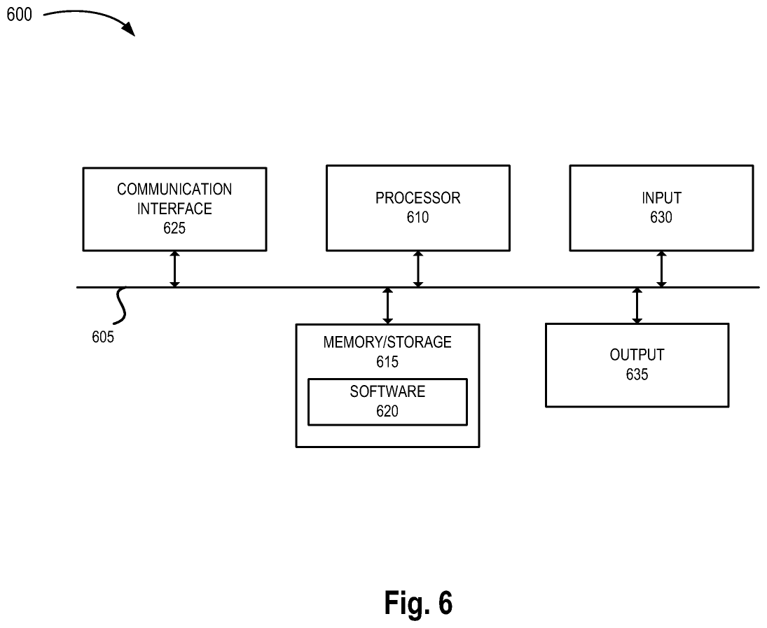

FIG. 6 is a diagram illustrating exemplary components of a device 600 that may be included in one or more of the devices described herein. For example, device 600 may correspond to access device 107, external device 117, core device 122, end device 130, PCF 202, NWDAF 204, AMF 206, UDM 208, SMF 304, UE-PCF 402, SM-PCF 404, MME 406, and/or other types of devices, as described herein. As illustrated in FIG. 6, device 600 includes a bus 605, a processor 610, a memory/storage 615 that stores software 620, a communication interface 625, an input 630, and an output 635. According to other embodiments, device 600 may include fewer components, additional components, different components, and/or a different arrangement of components than those illustrated in FIG. 6 and described herein.

Bus 605 includes a path that permits communication among the components of device 600. For example, bus 605 may include a system bus, an address bus, a data bus, and/or a control bus. Bus 605 may also include bus drivers, bus arbiters, bus interfaces, clocks, and so forth.

Processor 610 includes one or multiple processors, microprocessors, data processors, co-processors, graphics processing units (GPUs), application specific integrated circuits (ASICs), controllers, programmable logic devices, chipsets, field-programmable gate arrays (FPGAs), application specific instruction-set processors (ASIPs), system-on-chips (SoCs), central processing units (CPUs) (e.g., one or multiple cores), microcontrollers, neural processing unit (NPUs), and/or some other type of component that interprets and/or executes instructions and/or data. Processor 610 may be implemented as hardware (e.g., a microprocessor, etc.), a combination of hardware and software (e.g., a SoC, an ASIC, etc.), may include one or multiple memories (e.g., cache, etc.), etc.

Processor 610 may control the overall operation, or a portion of operation(s) performed by device 600. Processor 610 may perform one or multiple operations based on an operating system and/or various applications or computer programs (e.g., software 620). Processor 610 may access instructions from memory/storage 615, from other components of device 600, and/or from a source external to device 600 (e.g., a network, another device, etc.). Processor 610 may perform an operation and/or a process based on various techniques including, for example, multithreading, parallel processing, pipelining, interleaving, learning, model-based, etc.

Memory/storage 615 includes one or multiple memories and/or one or multiple other types of storage mediums. For example, memory/storage 615 may include one or multiple types of memories, such as, a random access memory (RAM), a dynamic RAM (DRAM), a static RAM (SRAM), a cache, a read only memory (ROM), a programmable ROM (PROM), an erasable PROM (EPROM), an electrically EPROM (EEPROM), a single in-line memory module (SIMM), a dual in-line memory module (DIMM), a flash memory (e.g., 2D, 3D, NOR, NAND, etc.), a solid state memory, and/or some other type of memory. Memory/storage 615 may include a hard disk (e.g., a magnetic disk, an optical disk, a magneto-optic disk, a solid-state component, etc.), a Micro-Electromechanical System (MEMS)-based storage medium, and/or a nanotechnology-based storage medium.

Memory/storage 615 may be external to and/or removable from device 600, such as, for example, a Universal Serial Bus (USB) memory stick, a dongle, a hard disk, mass storage, off-line storage, or some other type of storing medium. Memory/storage 615 may store data, software, and/or instructions related to the operation of device 600.

Software 620 includes an application or a program that provides a function and/or a process. As an example, with reference to PCF 202, software 620 may include an application that, when executed by processor 610, provides a function and/or a process of the registration support service, as described herein. As another example, with reference to AMF 206, software 620 may include an application that, when executed by processor 610, provides a function and/or a process of the registration support service, as described herein. As yet another example, with reference to MME 406, software 620 may include an application that, when executed by processor 610, provides a function and/or a process of the registration support service, as described herein. Software 620 may also include firmware, middleware, microcode, hardware description language (HDL), and/or another form of instruction. Software 620 may also be virtualized. Software 620 may further include an operating system (OS) (e.g., Windows, Linux, Android, proprietary, etc.).

Communication interface 625 permits device 600 to communicate with other devices, networks, systems, and/or the like. Communication interface 625 includes one or multiple wireless interfaces, optical interfaces, and/or wired interfaces. For example, communication interface 625 may include one or multiple transmitters and receivers, or transceivers. Communication interface 625 may operate according to a protocol stack and a communication standard. Communication interface 625 may support one or multiple MIMO, beamforming, and/or transmission/reception configurations.

Input 630 permits an input into device 600. For example, input 630 may include a keyboard, a mouse, a display, a touchscreen, a touchless screen, a button, a switch, an input port, speech recognition logic, and/or some other type of visual, auditory, tactile, affective, olfactory, etc., input component. Output 635 permits an output from device 600. For example, output 635 may include a speaker, a display, a touchscreen, a touchless screen, a light, an output port, and/or some other type of visual, auditory, tactile, etc., output component.

As previously described, a network device may be implemented according to various computing architectures (e.g., in a cloud, etc.) and according to various network architectures (e.g., a virtualized function, PaaS, etc.). Device 600 may be implemented in the same manner. For example, device 600 may be instantiated, created, deleted, or some other operational state during its life-cycle (e.g., refreshed, paused, suspended, rebooted, or another type of state or status), using well-known virtualization technologies. For example, access device 107, core device 122, external device 117, and/or another type of network device or end device 130, as described herein, may be a virtualized device.

Device 600 may be configured to perform a process and/or a function, as described herein, in response to processor 610 executing software 620 stored by memory/storage 615. By way of example, instructions may be read into memory/storage 615 from another memory/storage 615 (not shown) or read from another device (not shown) via communication interface 625. The instructions stored by memory/storage 615 cause processor 610 to perform a function or a process described herein. Alternatively, for example, according to other implementations, device 600 may be configured to perform a function or a process described herein based on the execution of hardware (processor 610, etc.).

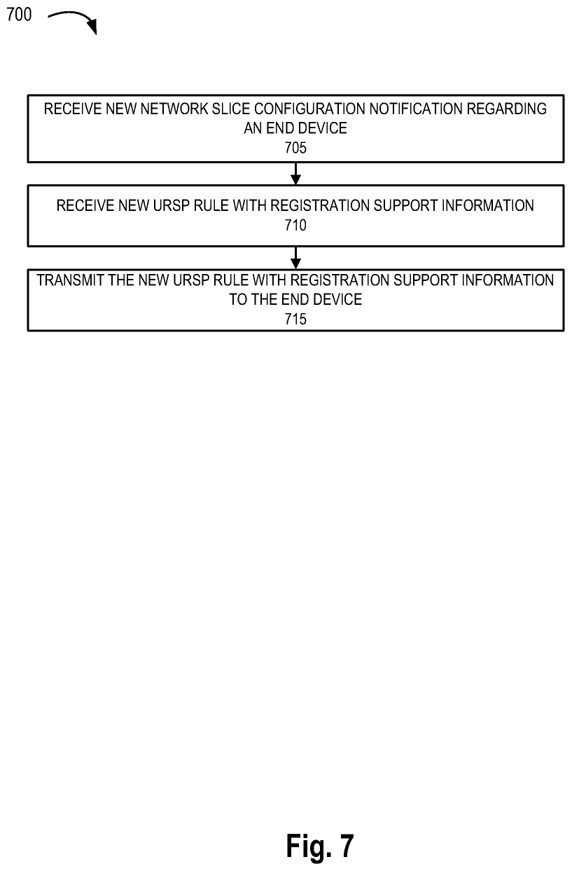

FIG. 7 is a flow diagram illustrating an exemplary process 700 of an exemplary embodiment of the registration support service. According to an exemplary embodiment, an AMF (e.g., AMF 206) or a future generation network device (e.g., core device 122) that may perform similar functions to the AMF may perform process 700. According to an exemplary implementation, processor 610 executes software 620 to perform a step (in whole or in part) of process 700, as described herein. Alternatively, a step (in whole or in part) may be performed by execution of only hardware.

Referring to FIG. 7, in block 705, AMF 206 may receive a new network slice configuration notification regarding end device 130, as described herein.

In block 710, AMF 206 may receive a new URSP rule that includes registration support information, as described herein.

In block 715, AMF 206 may transmit the new URSP rule that includes registration support information to end device 130, as described herein.

FIG. 7 illustrates an exemplary process 700 of the registration support service, however, according to other exemplary embodiments, the registration support service may perform additional operations, fewer operations, and/or different operations than those illustrated and described in relation to FIG. 7. For example, AMF 206 may perform additional and/or different operations or steps as described elsewhere in this description.

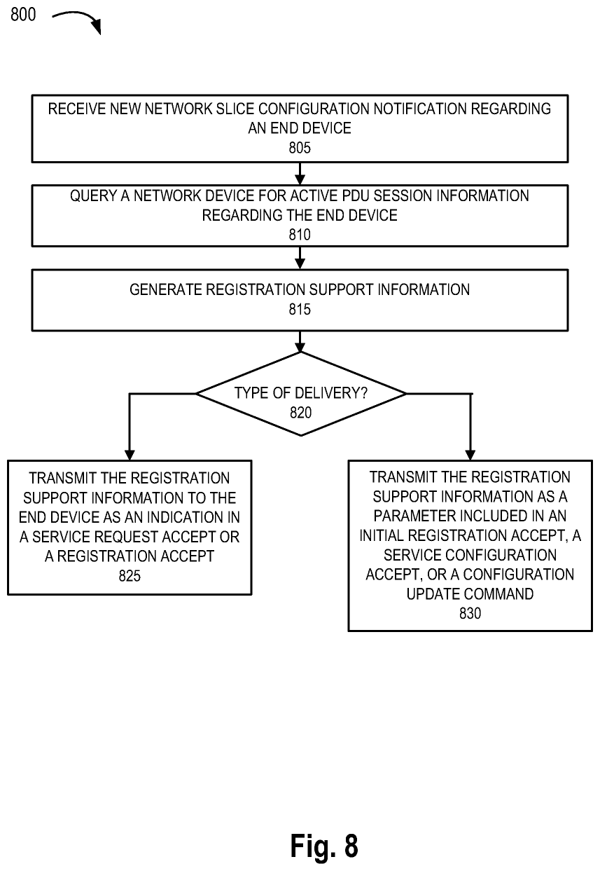

FIG. 8 is a flow diagram illustrating an exemplary process 800 of an exemplary embodiment of the registration support service. According to an exemplary embodiment, an AMF (e.g., AMF 206) or a future generation network device (e.g., core device 122) that may perform similar functions to the AMF may perform process 800. According to an exemplary implementation, processor 610 executes software 620 to perform a step (in whole or in part) of process 800, as described herein. Alternatively, a step (in whole or in part) may be performed by execution of only hardware.

Referring to FIG. 8, in block 805, AMF 206 may receive a new network slice configuration notification regarding end device 130, as described herein.

In block 810, AMF 206 may query a network device for active PDU session information regarding end device 130, as described herein.

In block 815, AMF 206 may generate registration support information, as described herein.

In block 820, AMF 206 may determine a type of delivery of the registration support information based on whether there is an active PDU session, as described herein. For example, in block 825, AMF 206 may transmit the registration support information to end device 130 as an indication in a service request accept or a registration accept. Alternatively, in block 830, AMF 206 may transmit the registration support information as a parameter included in an initial registration accept message, a service configuration accept message, or a configuration update command message, as described herein.

FIG. 8 illustrates an exemplary process of the registration support service, however, according to other exemplary embodiments, the registration support service may perform additional operations, fewer operations, and/or different operations than those illustrated and described in relation to FIG. 8. For example, AMF 206 may perform additional and/or different operations as described elsewhere in this description.

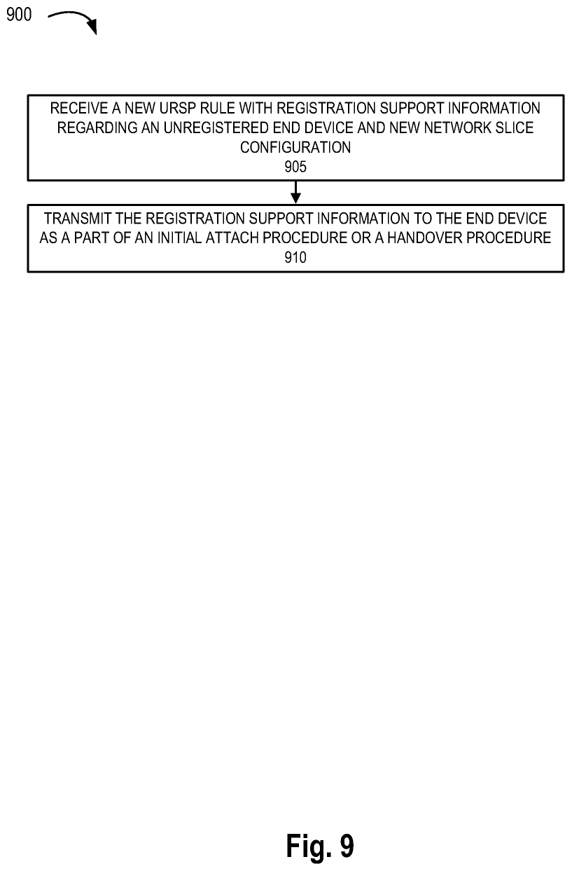

FIG. 9 is a flow diagram illustrating an exemplary process 900 of an exemplary embodiment of the registration support service. According to an exemplary embodiment, an MME (e.g., MME 406) or a future generation network device (e.g., core device 122) that may perform similar functions to the MME may perform process 900. According to an exemplary implementation, processor 610 executes software 620 to perform a step (in whole or in part) of process 900, as described herein. Alternatively, a step (in whole or in part) may be performed by execution of only hardware.

Referring to FIG. 9, in block 905, MME 406 may receive a new URSP rule with registration support information regarding an unregistered end device and a new network slice configuration, as described herein.

In block 910, MME 406 may transmit the registration support information to end device 130 as a part of an initial attach procedure or a handover procedure, as described herein.

FIG. 9 illustrates an exemplary process of the registration support service, however, according to other exemplary embodiments, the registration support service may perform additional operations, fewer operations, and/or different operations than those illustrated and described in relation to FIG. 9. For example, MME 406 may perform additional and/or different operations as described elsewhere in this description.

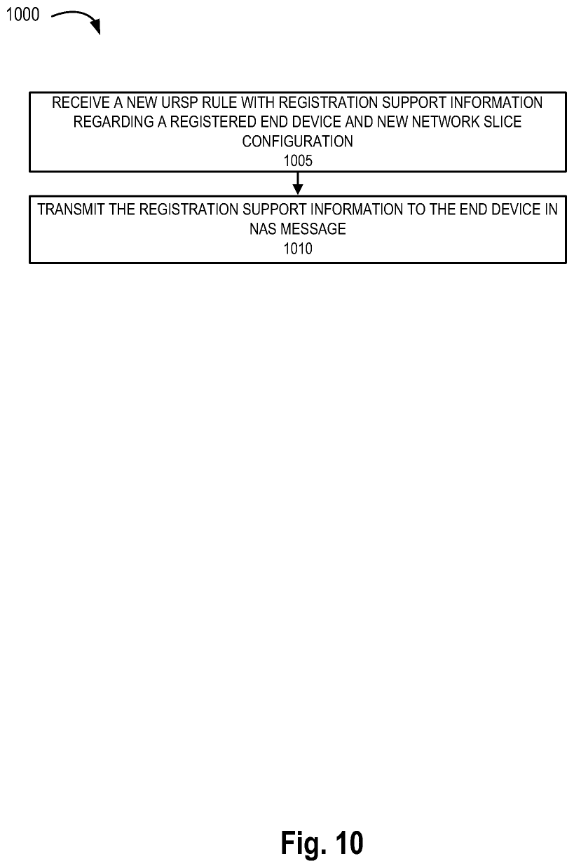

FIG. 10 is a flow diagram illustrating an exemplary process 1000 of an exemplary embodiment of the registration support service. According to an exemplary embodiment, an MME (e.g., MME 406) or a future generation network device (e.g., core device 122) that may perform similar functions to the MME may perform process 1000. According to an exemplary implementation, processor 610 executes software 620 to perform a step (in whole or in part) of process 1000, as described herein. Alternatively, a step (in whole or in part) may be performed by execution of only hardware.

Referring to FIG. 10, in block 1005, MME 406 may receive a new URSP rule with registration support information regarding a registered end device and a new network slice configuration, as described herein.

In block 1010, MME 406 may transmit the registration support information to end device 130 in a NAS message, as described herein.

FIG. 10 illustrates an exemplary process of the registration support service, however, according to other exemplary embodiments, the registration support service may perform additional operations, fewer operations, and/or different operations than those illustrated and described in relation to FIG. 10. For example, MME 406 may perform additional and/or different operations as described elsewhere in this description.

As set forth in this description and illustrated by the drawings, reference is made to “an exemplary embodiment,” “exemplary embodiments,” “an embodiment,” “embodiments,” etc., which may include a particular feature, structure, or characteristic in connection with an embodiment(s). However, the use of the phrase or term “an embodiment,” “embodiments,” etc., in various places in the description does not necessarily refer to all embodiments described, nor does it necessarily refer to the same embodiment, nor are separate or alternative embodiments necessarily mutually exclusive of other embodiment(s). The same applies to the term “implementation,” “implementations,” etc.

The foregoing description of embodiments provides illustration but is not intended to be exhaustive or to limit the embodiments to the precise form disclosed. Accordingly, modifications to the embodiments described herein may be possible. For example, various modifications and changes may be made thereto, and additional embodiments may be implemented, without departing from the broader scope of the invention as set forth in the claims that follow. The description and drawings are accordingly to be regarded as illustrative rather than restrictive.

The terms “a,” “an,” and “the” are intended to be interpreted to include one or more items. Further, the phrase “based on” is intended to be interpreted as “based, at least in part, on,” unless explicitly stated otherwise. The term “and/or” is intended to be interpreted to include any and all combinations of one or more of the associated items. The word “exemplary” is used herein to mean “serving as an example.” Any embodiment or implementation described as “exemplary” is not necessarily to be construed as preferred or advantageous over other embodiments or implementations.

In addition, while series of blocks have been described regarding the processes illustrated in FIGS. 7, 8, 9, and 10, the order of the blocks may be modified according to other embodiments. Further, non-dependent blocks may be performed in parallel. Additionally, other processes described in this description may be modified and/or non-dependent operations may be performed in parallel. Further, one or more respective steps of a process illustrated in FIGS. 7, 8, 9, and/or 10, may be included in another process illustrated in FIGS. 7, 8, 9, and/or 10.

Embodiments described herein may be implemented in many different forms of software executed by hardware. For example, a process or a function may be implemented as “logic,” a “component,” or an “element.” The logic, the component, or the element, may include, for example, hardware (e.g., processor 610, etc.), or a combination of hardware and software (e.g., software 620).

Embodiments have been described without reference to the specific software code because the software code can be designed to implement the embodiments based on the description herein and commercially available software design environments and/or languages. For example, diverse types of programming languages including, for example, a compiled language, an interpreted language, a declarative language, or a procedural language may be implemented.

Use of ordinal terms such as “first,” “second,” “third,” etc., in the claims to modify a claim element does not by itself connote any priority, precedence, or order of one claim element over another, the temporal order in which acts of a method are performed, the temporal order in which instructions executed by a device are performed, etc., but are used merely as labels to distinguish one claim element having a certain name from another element having a same name (but for use of the ordinal term) to distinguish the claim elements.

Additionally, embodiments described herein may be implemented as a non-transitory computer-readable storage medium that stores data and/or information, such as instructions, program code, a data structure, a program module, an application, a script, or other known or conventional form suitable for use in a computing environment. The program code, instructions, application, etc., is readable and executable by a processor (e.g., processor 610) of a device. A non-transitory storage medium includes one or more of the storage mediums described in relation to memory/storage 615. The non-transitory computer-readable storage medium may be implemented in a centralized, distributed, or logical division that may include a single physical memory device or multiple physical memory devices spread across one or multiple network devices.

To the extent the aforementioned embodiments collect, store, or employ personal information of individuals, it should be understood that such information shall be collected, stored, and used in accordance with all applicable laws concerning protection of personal information. Additionally, the collection, storage and use of such information can be subject to the consent of the individual to such activity, for example, through well known “opt-in” or “opt-out” processes as can be appropriate for the situation and type of information. Collection, storage, and use of personal information can be in an appropriately secure manner reflective of the type of information, for example, through various encryption and anonymization techniques for particularly sensitive information.

No element, act, or instruction set forth in this description should be construed as critical or essential to the embodiments described herein unless explicitly indicated as such.

All structural and functional equivalents to the elements of the various aspects set forth in this disclosure that are known or later come to be known are expressly incorporated herein by reference and are intended to be encompassed by the claims.

What is claimed is:

1. A method comprising:
receiving, by a network device, a new network slice configuration notification pertaining to an end device;
transmitting, by the network device, a first message, which includes a new network slice configuration, to the end device;
receiving, by the network device, a second message that includes registration support information regarding re-registration of the end device with the network device;
transmitting, by the network device, a third message, which includes the registration support information, to the end device; and
performing, by the network device, a re-registration procedure initiated by the end device based on the registration support information.

2. The method of claim 1, wherein the registration support information indicates at least a time period or a location that the end device is to initiate the re-registration procedure.

3. The method of claim 1, wherein the registration support information correlates to at least one network slice included in the new network slice configuration.

4. The method of claim 1, wherein the registration support information is included in a new user equipment route selection policy (URSP) rule.

5. The method of claim 1, further comprising:
receiving, by the network device, a response to the third message from the end device; and
transmitting, by the network device, the response to a policy control function device of a core network.

6. The method of claim 1, wherein the registration support information is generated based on historical behavior of the end device.

7. The method of claim 1, wherein the first message and the third message are non-access stratum messages.

8. The method of claim 1, wherein the network device is an access and mobility management function (AMF).

9. A network device comprising:
a processor that is configured to:
receive, a new network slice configuration notification pertaining to an end device;
transmit a first message, which includes a new network slice configuration, to the end device;
receive a second message that includes registration support information regarding re-registration of the end device with the network device;
transmit a third message, which includes the registration support information, to the end device; and
perform a re-registration procedure initiated by the end device based on the registration support information.

10. The network device of claim 9, wherein the registration support information indicates at least a time period or a location that the end device is to initiate the re-registration procedure.

11. The network device of claim 9, wherein the registration support information correlates to at least one network slice included in the new network slice configuration.

12. The network device of claim 9, wherein the registration support information is included in a new user equipment route selection policy (URSP) rule.

13. The network device of claim 9, wherein the processor is further configured to:
receive a response to the third message from the end device; and
transmit the response to a policy control function device of a core network.

14. The network device of claim 9, wherein the registration support information is generated based on historical behavior of the end device.

15. The network device of claim 9, wherein the first message and the third message are non-access stratum messages.

16. The network device of claim 9, wherein the network device is an access and mobility management function (AMF).

17. A non-transitory computer-readable storage medium storing instructions executable by a processor of a network device, wherein the instructions are configured to:
receive, a new network slice configuration notification pertaining to an end device;
transmit a first message, which includes a new network slice configuration, to the end device;
receive a second message that includes registration support information regarding re-registration of the end device with the network device;
transmit a third message, which includes the registration support information, to the end device; and
perform a re-registration procedure initiated by the end device based on the registration support information.

18. The non-transitory computer-readable storage medium of claim 17, wherein the registration support information is generated based on historical behavior of the end device.

19. The non-transitory computer-readable storage medium of claim 17, wherein the registration support information indicates at least a time period or a location that the end device is to initiate the re-registration procedure.

20. The non-transitory computer-readable storage medium of claim 17, wherein the network device is an access and mobility management function (AMF).
